(19) United States
(12) Patent Application Publication
(10) Pub. No.: US 2012/0201448 A1
(43) Pub. Date: Aug. 9, 2012

(54) ROBOTIC DEVICE, INSPECTION DEVICE, INSPECTION METHOD, AND INSPECTION PROGRAM

(75) Inventors: Takashi NAMMOTO, Sendai (JP); Koichi HASHIMOTO, Sendai (JP); Tomohiro INOUE, Sendai (JP)

(73) Assignee: SEIKO EPSON CORPORATION, Tokyo (JP)

(21) Appl. No.: 13/364,741

(22) Filed: Feb. 2, 2012

(30) Foreign Application Priority Data
Feb. 3, 2011 (JP) 2011-021878

(51) Int. Cl. G06K 9/68; G06K 9/00

(52) U.S. Cl. 382/153; 382/218; 901/47

(57) ABSTRACT

A robotic device includes an imaging section adapted to take an image of an object having a hole, and generate an image data of the object including an inspection area of an image of the hole, a robot adapted to move the imaging section, an inspection area luminance value detection section adapted to detect a luminance value of the inspection area from the image data, a reference area luminance value detection section adapted to detect a luminance value of a reference area adjacent to the inspection area from the image data, and a determination section adapted to determine a state of the inspection area based on one of a ratio and a difference between the luminance value of the inspection area detected by the inspection area luminance value detection section and the luminance value of the reference area detected by the reference area luminance value detection section.

### BACKGROUND

1. Technical Field

The present invention relates to a robotic device, an inspection device, an inspection program, and an inspection method.

2. Related Art

There has been known a technology of performing inspection of a recognition object based on an image recognition process (see, e.g., JP-A-2-166566). The image recognition device disclosed in this document is for separately extracting a plurality of color components from a color image obtained by taking the image of the recognition object, then binarizing them color by color and then combining them, and then determining presence or absence of the recognition object based on the image thus combined. Specifically, assuming that a screw on which zinc plating is performed and further a yellow chromate process is performed is the recognition object, the image recognition device is a device for respectively extracting reddish yellow and greenish yellow, then recognizing presence or absence of the head of the screw based on the combined image obtained by binarizing each component and then combining the binarized components.

However, in the image recognition device described above, if an image having a color similar to the color of the screw is included in an image area other than the image of the screw head in the taken image, the image might be misidentified as the screw. Further, the color components as the extraction object are determined in advance, and are not varied in accordance with, for example, conditions of illumination or outside light and conditions of shooting. Therefore, if an imaging device automatically controlling the exposure in accordance with the intensity of the illumination or the illuminance of the outside light is used, since the dynamic range of the exposure varies in accordance with the variation in the illumination environment, the recognition rate of the screw varies.

### SUMMARY

An advantage of the invention is to provide a robotic device, an inspection device, an inspection program, and an inspection method each capable of performing robust appearance inspection with respect to the variation in illumination conditions and shooting conditions.

[1] An aspect of the invention is directed to a robotic device including an imaging section adapted to take an image of an inspection target object having an inspection region, and generate an image data of an inspection target object image including an inspection area as an image area corresponding to the inspection region, a robot main body adapted to movably support the imaging section, an inspection area luminance value detection section adapted to detect a luminance value of the inspection area from the image data generated by the imaging section, a reference area luminance value detection section adapted to detect a luminance value of a reference area adjacent to the inspection area from the image data, and a determination section adapted to determine a state of the inspection area based on one of a ratio and a difference between the luminance value of the inspection area detected by the inspection area luminance value detection section and the luminance value of the reference area detected by the reference area luminance value detection section.

Here, the reference area adjacent to the inspection area denotes the peripheral area in a level of capable of fulfilling a first requirement of being similar to the structural state of the inspection area and a second requirement of being similar to the state of the light reflection from the inspection area. For example, in many cases, in the appearance of the inspection target object, the mechanical structure of the region corresponding to the inspection area and the structure of the region corresponding to the peripheral area adjacent to the inspection area are the same as or similar to each other. Further, the state of the reflection of the outside light or the indoor light from the region corresponding to the inspection area and the state of the reflection thereof from the region corresponding to the peripheral area can be regarded to be similar to each other providing the distance between the both areas is short. Therefore, the area adjacent to the inspection area can be set to the area obtained by, for example, sectioning the area fulfilling the first and second requirements described above with the circular area represented by a predetermined length of the radius from the center position of the inspection area.

Further, in the case in which, for example, the imaging section is a camera automatically adjusting the dynamic range of the exposure in accordance with the intensity of the illumination, it is preferable for the determination section to determine the state of the inspection area based on the ratio between the luminance value of the inspection area and the luminance value of the reference area. On this occasion, the determination section obtains the ratio by, for example, dividing the luminance value of the inspection area by the luminance value of the reference area. If, for example, the ratio is a value equal to or lower than a threshold value, the determination section determines that the inspection object (e.g., the head of the screw) is present in the inspection area. Further, if the ratio is a value exceeding the threshold value, the determination section determines that the inspection object is absent from the inspection area.

Further, in the case in which, for example, the imaging section is a camera, which does not automatically adjust the dynamic range of the exposure in accordance with the intensity of the illumination, it is possible for the determination section to determine the state of the inspection area based on the difference between the luminance value of the inspection area and the luminance value of the reference area. On this occasion, the determination section obtains the difference between the luminance value of the inspection area and the luminance value of the reference area, and determines that the inspection object is present in the inspection area if, for example, the difference is a value equal to or lower than a threshold value. Further, if the difference is a value exceeding the threshold value, the determination section determines that the inspection object is absent from the inspection area.

Since such a configuration is adopted, the robotic device can correctly perform the inspection of the state of the inspection region while suppressing the influence of the outside light and the illumination.

[2] This aspect of the invention is directed to the robotic device according to [1] described above, wherein the reference area luminance value detection section detects the luminance value of the reference area, which is an area adjacent to the inspection area and having a spatial frequency component smaller than a threshold value, from the image data. Since such a configuration is adopted, the robotic device can use the luminance value of the reference area fulfilling the requirement of being similar to the structural state of the inspection area as the first requirement described above.

[3] This aspect of the invention is directed to the robotic device according to [1] described above, wherein the reference area luminance value detection section detects the luminance value of the reference area, which is an area adjacent to the inspection area and having a reflectance lower than a threshold level, from the image data.

Since such a configuration is adopted, the robotic device can use the luminance value of the reference area fulfilling the requirement of being similar to the state of the light reflection from the inspection area as the second requirement described above.

[4] This aspect of the invention is directed to the robotic device according to [1] described above, which further provides a template image storage section adapted to store template image data of the inspection target object, and a reference area determination section adapted to determine an area adjacent to the area corresponding to the inspection area as the reference area in the template image data stored in the template image storage section, and the reference area luminance value detection section detects a luminance value of an area of the image data corresponding to the reference area determined by the reference area determination section. Since such a configuration is adopted, it is possible for the robotic device to store the template image data of the inspection target object to the template image storage section to thereby automatically determine the reference area.

[5] This aspect of the invention is directed to the robotic device according to [4] described above, wherein the reference area determination section determines an area, which is adjacent to an area corresponding to the inspection area, and has a spatial frequency component smaller than a threshold value, as the reference area in the template image data stored in the template image storage section.

Since such a configuration is adopted, the robotic device can use the luminance value of the reference area fulfilling the requirement of being similar to the structural state of the inspection area as the first requirement described above.

[6] This aspect of the invention is directed to the robotic device according to [4] described above, wherein the reference area determination section determines an area, which is adjacent to an area corresponding to the inspection area, and has a reflectance lower than a threshold level, as the reference area in the template image data stored in the template image storage section.

Since such a configuration is adopted, the robotic device can use the luminance value of the reference area fulfilling the requirement of being similar to the state of the light reflection from the inspection area as the second requirement described above.

[7] This aspect of the invention is directed to the robotic device according to any of [4] to [6] described above, which further provides a template image feature point extraction section adapted to extract a feature point from the template image data stored in the template image storage section, an inspection image feature point extraction section adapted to extract a feature point from the image data generated by the imaging section, and a converted image generation section adapted to perform perspective projection conversion on the image data to thereby generate converted image data based on the feature point extracted by the template image feature point extraction section and the feature point extracted by the inspection image feature point extraction section, and the robot main body movably supports the imaging section in a three-dimensional space, the inspection area luminance value detection section detects the luminance value of an area corresponding to the inspection area from the converted image data generated by the converted image generation section, and the reference area luminance value detection section detects the luminance value of an area corresponding to the reference area determined by the reference area determination section from the converted image data.

Since such a configuration is adopted, it is possible for the robotic device to perform inspection of the state of the inspection region using the image data taken from an arbitrary direction in the three-dimensional space.

[8] This aspect of the invention is directed to the robotic device according to any of [4] to [6] described above, which further provides a template image feature point extraction section adapted to extract a feature point from the template image data stored in the template image storage section, an inspection image feature point extraction section adapted to extract a feature point from the image data generated by the imaging section, and a displacement acquisition section adapted to acquire a displacement of the inspection target object image of the image data with respect to the template image of the template image data based on the feature point extracted by the template image feature point extraction section and the feature point extracted by the inspection image feature point extraction section, and the robot main body supports the imaging section so as to be able to translate in a three-dimensional space, and the reference area luminance value detection section detects a luminance value of an area specified based on the image data and the displacement acquired by the displacement acquisition section.

Since such a configuration is adopted, it is possible for the robotic device to perform inspection of the state of the inspection region using the image data taken by the imaging section making a translational displacement.

[9] This aspect of the invention is directed to an inspection device including an inspection area luminance value detection section adapted to detect a luminance value of an inspection area from image data including the inspection area, a reference area luminance value detection section adapted to detect a luminance value of a reference area adjacent to the inspection area from the image data, and a determination section adapted to determine a state of the inspection area based on one of a ratio and a difference between the luminance value of the inspection area detected by the inspection area luminance value detection section and the luminance value of the reference area detected by the reference area luminance value detection section.

[10] This aspect of the invention is directed to an inspection program adapted to allow a computer to function as a device including an inspection area luminance value detection section adapted to detect a luminance value of an inspection area from image data including the inspection area, a reference area luminance value detection section adapted to detect a luminance value of a reference area adjacent to the inspection area from the image data, and a determination section adapted to determine a state of the inspection area based on one of a ratio and a difference between the luminance value of the inspection area detected by the inspection area luminance value detection section and the luminance value of the reference area detected by the reference area luminance value detection section.

[11] This aspect of the invention is directed to an inspection method including: allowing an inspection area luminance value detection section to detect a luminance value of an inspection area from image data including the inspection area, allowing a reference area luminance value detection section to detect a luminance value of a reference area adjacent to the inspection area from the image data, and allowing a determination section to determine a state of the inspection area based on one of a ratio and a difference between the luminance value of the inspection area detected by the inspection area luminance value detection section in the detection of the luminance value of the inspection area and the luminance value of the reference area detected by the reference area luminance value detection section in the detection of the luminance value of the reference area.

Therefore, according to any one of the above aspects of the invention, the appearance inspection robust to the variation in the illumination conditions and the shooting conditions can be performed.

### BRIEF DESCRIPTION OF THE DRAWINGS

The invention will be described with reference to the accompanying drawings, wherein like numbers reference like elements.

FIG. 1 is a schematic appearance diagram of a robot and an inspection target object in a robotic device according to a first embodiment of the invention.

FIG. 2 is a block diagram showing a schematic functional configuration of the robotic device according to the present embodiment.

FIG. 3 is a block diagram showing a functional configuration of an inspection device in the present embodiment.

FIG. 4 is a block diagram showing a functional configuration of a converted image generation section in the present embodiment.

FIG. 5 is a diagram schematically showing a template image and position information of an inspection area in the template image in an overlapping manner.

FIG. 6 is a flowchart showing a procedure of a process of the inspection device generating template image feature point data in the present embodiment.

FIG. 7 is a flowchart showing a procedure of a process of the inspection device determining the reference area in the present embodiment.

FIG. 8 is a flowchart showing a procedure of a process of an inspection device inspecting missing of a screw as an inspection object with respect to single frame image data of the inspection target object taken by an imaging device.

FIG. 9 is a block diagram showing a schematic functional configuration of a robotic device according to a second embodiment.

FIG. 10 is a block diagram showing a functional configuration of an inspection device in the present embodiment.

FIG. 11 is a block diagram showing a functional configuration of a displacement acquisition section in the present embodiment.

FIG. 12 is a diagram schematically showing an inspection target object image and position information of the inspection area in the template image data and the image data in an overlapping manner.

FIG. 13 is a flowchart showing a procedure of a process of the inspection device inspecting missing of a screw with respect to the single frame image data of the inspection target object taken by the imaging device.

FIG. 14 is a schematic appearance diagram of a robot and an inspection target object in a robotic device according to another embodiment of the invention.

### DESCRIPTION OF EXEMPLARY EMBODIMENTS

Some embodiments of the invention will hereinafter be described in detail with reference to the accompanying drawings.

### First Embodiment

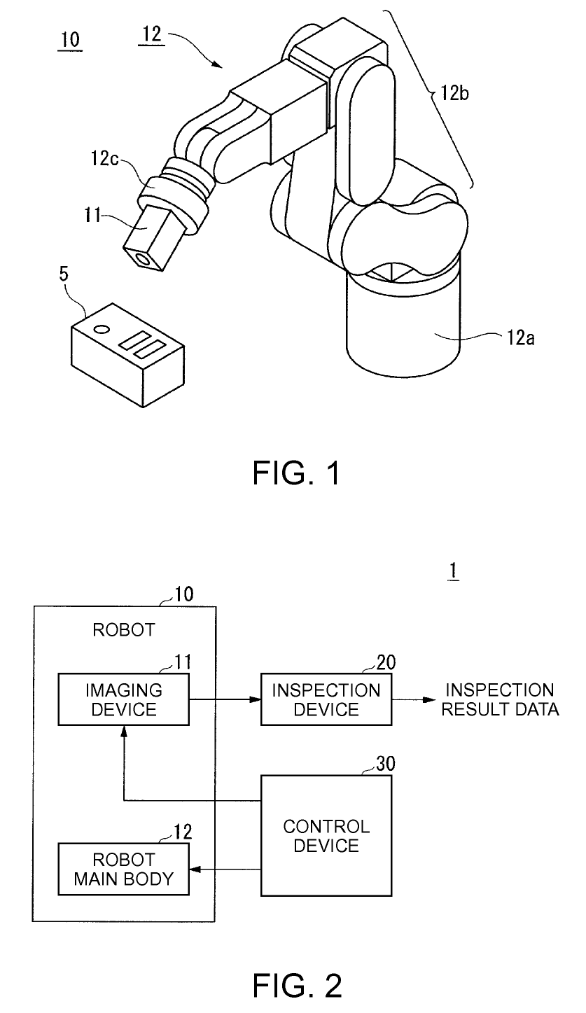

FIG. 1 is a schematic appearance diagram of a robot and an inspection target object in a robotic device according to a first embodiment of the invention. As shown in the drawing, the robot 10 is configured by providing an imaging device (an imaging section) 11 to a robot main body 12.

The robot main body 12 supports the imaging device 11 in a movable manner. Specifically, the robot main body 12 is configured including a support base 12a fixed to the ground, an arm section 12b coupled to the support base 12a so as to be able to rotate, bend, and stretch, and a hand section 12c coupled to the arm section 12b so as to be able to rotate and swing. The robot main body 12 is, for example, a six-axis vertical articulated robot having six degrees of freedom due to the tandem operation of the support base 12a, the arm section 12b, and the hand section 12c, and the position and the direction of the imaging section 11 can freely be changed in a three-dimensional space.

It should be noted that the robot main body 12 can be arranged to selectively grip the imaging device 11, tools, components, and so on in accordance with the purpose of the operation.

Further, the number of degrees of freedom of the robot main body 12 is not limited to six. Further, the support base 12a can be installed in a place fixed to the ground such as a wall or a ceiling. Further, the robot main body 12 can be arranged to have a configuration in which an arm section and a hand section, which are not shown, for supporting a tool or a component are provided in addition to the arm section 12b and the hand section 12c for supporting the imaging device 11, and the plurality of arm sections and hand sections is operated independently or in cooperation.

Further, as shown in FIG. 1, within a movable range of the tip of the hand section 12c of the robot 10, for example, the inspection target object 5 as an object of the appearance inspection is mounted on a stage not shown. The inspection target object 5 has an inspection region.

In other words, the robotic device according to the present embodiment is a device for inspecting the appearance of the inspection target object 5 to thereby check the state of the inspection region, specifically, whether or not an inspection object is present in the inspection region. In the present embodiment, an example in which the inspection region corresponds to an attachment region of a screw, and the inspection object corresponds to the head (hereinafter also referred to simply as a “screw” in some cases) of the screw will be explained.

FIG. 2 is a block diagram showing a schematic functional configuration of the robotic device according to the present embodiment. As shown in the drawing, the robotic device 1 is provided with the robot 10, an inspection device 20, and a control device 30.

As also shown in FIG. 1, the robot 10 is provided with the imaging device 11 and the robot main body 12.

The imaging device 11 is a video camera device capable of monochrome shooting or color shooting of automatically adjusting the exposure in accordance with, for example, the intensity of the illumination, taking images at a frame rate of, for example, 30 frame/second (fps), and then outputting the image data. It should be noted that the imaging device 11 can also be a still image camera. The imaging device 11 takes an image of the inspection target object 5 shown in the drawing and then outputs the image data in accordance with an imaging start request signal supplied from the control device 30. Further, the imaging device 11 stops the imaging operation in accordance with an imaging stop request signal supplied from the control device 30.

As described above, the robot main body 12 is a device for moving the imaging device 11 attached thereto in the three-dimensional space.

The inspection device 20 acquires the image data, which is continuously output by the imaging device 11 of the robot 10, sequentially or every several frames. Then, the inspection device 20 converts each of the image data thus acquired so that the viewpoint (the imaging direction) with respect to the image (an inspection target object image) of the inspection target object 5 included in the image data coincides with the viewpoint with respect to a template image included in template image data stored in advance. Then, the inspection device 20 determines presence or absence of the head of the screw as the inspection object from the inspection area in the image data (the converted image data) thus converted, and then outputs the inspection result data.

The control device 30 transmits control signals such as the imaging start request signal and the imaging stop request signal to the imaging device 11. Further, the control device 30 controls the posture of the robot main body 12 for changing the imaging direction of the imaging device 11 in the three-dimensional space.

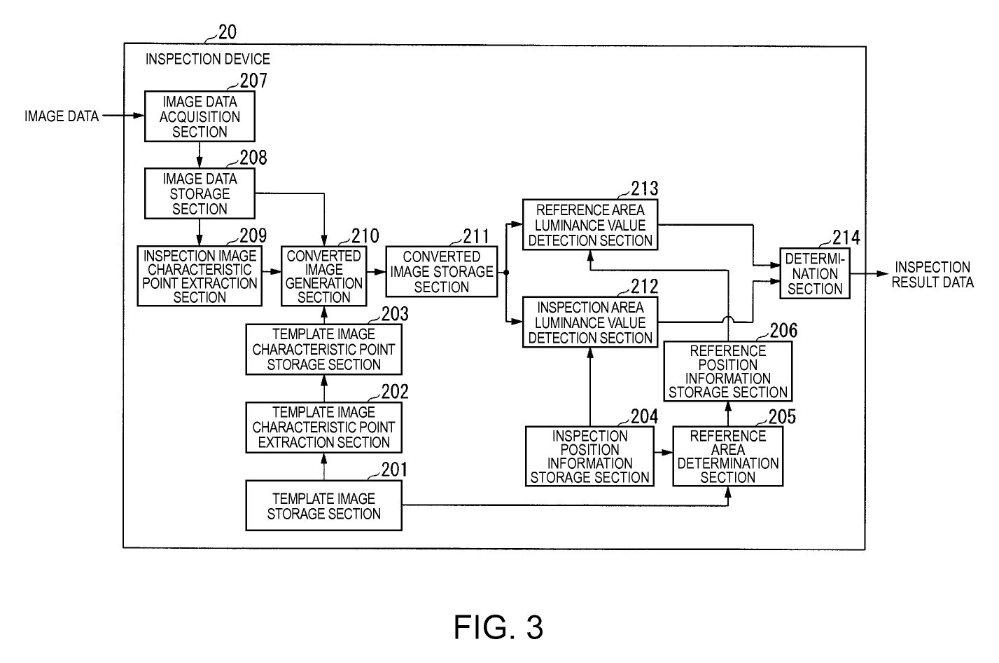

FIG. 3 is a block diagram showing a functional configuration of the inspection device 20. As shown in the drawing, the inspection device 20 is provided with a template image storage section 201, a template image feature point extraction section 202, a template image feature point storage section 203, an inspection position information storage section 204, a reference area determination section 205, a reference position information storage section 206, an image data acquisition section 207, an image data storage section 208, an inspection image feature point extraction section 209, a converted image generation section 210, a converted image storage section 211, an inspection area luminance value detection section 212, a reference area luminance value detection section 213, and a determination section 214.

The template image storage section 201 stores the template image data as the data of the template image obtained by taking the image of a reference (e.g., a sample of the inspection target object 5 normally attached with the screw) of the inspection target object 5 from a predetermined direction, for example, on an extension of the shaft center of the screw. It is enough for the template image data to have at least luminance information. In other words, the template image data can be monochrome image data or color image data.

The template image feature point extraction section 202 reads the template image data from the template image storage section 201, then extracts a plurality of feature points from the template image data, and then stores template image feature point data, which has image feature value in each of the feature points and the position information on the template image so as to correspond to each other, into the template image feature point storage section 203. For example, the template image feature point extraction section 202 performs a process of the scale invariant feature transform (SIFT) method known to the public for checking the state of the Gaussian distribution of the luminance for each of the small areas each including a plurality of pixels, and then extracting the feature points to thereby obtain the SIFT feature value. On this occasion, the SIFT feature value is expressed by, for example, a 128-dimensional vector.

Further, the template image feature point extraction section 202 can adopt the speed-up robust features (SURF) as the feature point extraction method.

The position information on the template image is a position vector of the feature point obtained by using, for example, the upper left end position of the template image as the origin. The template image feature point storage section 203 stores the template image feature point data having the image feature value in each of the plurality of feature points extracted by the template image feature point extraction section 202 and the position information on the template image so as to correspond to each other.

The inspection position information storage section 204 stores the position information (the inspection position information) for identifying the inspection area in the template image data. In the case in which, for example, the inspection area is a circular area corresponding to the attachment region (a screw hole) of the screw as the inspection region, the inspection position information storage section 204 stores the position vector of the center point of the circular area and the length of the radius of the circular area as the inspection position information. It should be noted that a rectangular area can also be adopted instead of the circular area.

The reference area determination section 205 reads the template image data from the template image storage section 201, and reads the inspection position information from the inspection position information storage section 204. Further, the reference area determination section 205 determines a flat area adjacent to the inspection area specified by the inspection position information as the reference area in the template image data, and then stores the position information (the reference position information) for specifying the reference area to the reference position information storage section 206. The area adjacent to the inspection area denotes the peripheral area in a level of capable of fulfilling a first requirement of being similar to the structural state of the inspection area and a second requirement of being similar to the state of the light reflection from the inspection area. For example, in many cases, in the appearance of the inspection target object 5, the mechanical structure of the region corresponding to the inspection area and the structure of the region corresponding to the peripheral area adjacent to the inspection area are the same as or similar to each other.

Further, the state of the reflection of the outside light or the indoor light from the region corresponding to the inspection area and the state of the reflection thereof from the region corresponding to the peripheral area can be regarded to be similar to each other providing the distance between the both areas is short. Therefore, the area adjacent to the inspection area can be set to the area obtained by, for example, sectioning the area fulfilling the first and second requirements described above with the circular area represented by a predetermined length of the radius from the center position of the inspection area. Further, the flat area denotes the area in the condition in which, for example, there is no stereoscopic structure such as a bracket or an electronic component, and the luster is low (the reflectance is lower than a predetermined level). The reference position information corresponds to the position vector of the center point of the circular area and the length of the radius of the circular area.

As a specific example, in order to fulfill the first requirement described above, the reference area determination section 205 detects a first area having a spatial frequency component smaller than a threshold value determined in advance from the circular area adjacent to the inspection area in the template image data. Further, in order to fulfill the second requirement, the reference area determination section 205 detects an area having a reflectance equal to or lower than a predetermined level as the second area with low luster in the template image data. The reference area determination section 205 determines the first and second areas thus detected or either one of areas as the reference area, and stores the reference position information for specifying the reference area to the reference position information storage section 206.

As described above, according to the reference area determination section 205, the reference area can automatically be determined based on the template image data stored in the template image storage section 201.

The reference position information storage section 206 stores the reference position information for specifying the reference area determined by the reference area determination section 205.

The image data acquisition section 207 acquires the image data, which is continuously output by the imaging device 11 of the robot 10, sequentially or every several frames, and then stores it to the image data storage section 208.

The image data storage section 208 stores the image data acquired by the image data acquisition section 207.

The inspection image feature point extraction section 209 reads the image data from the image data storage section 208, then extracts a plurality of feature points from the image data, and then supplies the feature value (inspection image feature value) in each of the feature points to the converted image generation section 210. For example, the inspection image feature point extraction section 209 performs the process of the SIFT method described above to thereby obtain the SIFT feature value similarly to the template image feature point extraction section 202. Further, the inspection image feature point extraction section 209 can apply the SURF described above as the feature point extraction method.

The converted image generation section 210 acquires the inspection image feature value supplied from the inspection image feature point extraction section 209, reads the template image feature point data from the template image feature point storage section 203, and reads the image data from the image data storage section 208. Then, the converted image generation section 210 obtains the Euclidean distance with respect to all of the combinations of the inspection image feature values and the image feature values of the template image data to thereby select the pair (corresponding pair) having the inspection image feature value and the image feature value of the template image data in a correspondence relationship. Then, the converted image generation section 210 generates the converted image data based on the corresponding pairs and the image data so that the viewpoint with respect to the inspection target object image included in the image data coincides with the viewpoint with respect to the template image included in the template image data, and then stores the converted image data to the converted image data storage section 211.

The converted image storage section 211 stores the converted image data generated by the converted image generation section 210.

The inspection area luminance value detection section 212 reads the converted image data from the converted image storage section 211, and reads the inspection position information from the inspection position information storage section 204. Then, the inspection area luminance value detection section 212 detects the luminance value (the inspection area luminance value) of the inspection area specified by the inspection position information in the converted image data, and then supplies it to the determination section 214. The inspection area luminance value is, for example, an average value of the luminance values of the respective pixels in the inspection area.

The reference area luminance value detection section 213 reads the converted image data from the converted image storage section 211, and reads the reference position information from the reference position information storage section 206. Then, the reference area luminance value detection section 213 detects the luminance value (the reference area luminance value) of the reference area specified by the reference position information in the converted image data, and then supplies it to the determination section 214. The reference area luminance value is, for example, an average value of the luminance values of the respective pixels in the reference area.

The determination section 214 acquires the inspection area luminance value supplied from the inspection area luminance value detection section 212, and acquires the reference area luminance value supplied from the reference area luminance value detection section 213. Then, the determination section 214 determines whether or not the inspection object (the screw) is present in the inspection area based on the inspection area luminance value and the reference area luminance value, and then outputs the inspection result data as the determination result. Specifically, the determination section 214 calculates the luminance ratio lₛ′ using, for example, Formula (1) described below. It should be noted that in Formula (1), the symbol lₛ denotes the inspection area luminance value, and the symbol lᵣ denotes the reference area luminance value.

$${l}_{s}^{′} = \frac{{l}_{s}}{{l}_{r}} \qquad ( 1 )$$

If the luminance ratio lₛ′ is a value equal to or lower than a threshold value determined in advance, the determination section 214 determines that the screw is present in the inspection area, and outputs the information (e.g., “1”) representing the fact that the screw is present as the inspection result data. Further, if the luminance ratio lₛ′ is a value exceeding the threshold value, the determination section 214 determines that the screw is absent in the inspection area, and outputs the information (e.g., “0”) representing the fact that the screw is absent as the inspection result data.

In fact, the inspection area luminance value lₛ in the case in which the screw is present in the inspection area is higher than the inspection area luminance value lₛ in the case in which the screw is absent in the inspection area. However, in the case in which, for example, the imaging device 20 is a camera device automatically adjusting the dynamic range of the exposure in accordance with the intensity of the illumination or the illuminance of the outside light, the inspection area luminance value lₛ itself varies due to the variation in the shooting condition of the imaging device 20 itself. Therefore, by obtaining the ratio between the inspection area luminance value lₛ of the inspection area and the reference area luminance value lᵣ of the reference area located adjacent to the inspection area, an evaluation value with a little variation with respect to the variation in the illumination condition and the shooting condition can be obtained.

It should be noted that in the case in which the imaging device is a camera device not performing the operation of automatically adjusting the dynamic range of the exposure, the determination section 214 can obtain the difference between the inspection area luminance value lₛ and the reference area luminance value lᵣ to thereby determine presence or absence of the screw. Specifically, if the difference between the inspection area luminance value lₛ and the reference area luminance value lᵣ is a value equal to or lower than a threshold value determined in advance, the determination section 214 determines that the screw is present in the inspection area, and outputs the information (e.g., “1”) representing the fact that the screw is present as the inspection result data. Further, if the difference is a value exceeding the threshold value, the determination section 214 determines that the screw is absent in the inspection area, and outputs the information (e.g., “0”) representing the fact that the screw is absent as the inspection result data.

In the inspection device 20, the template image storage section 201, the template image feature point storage section 203, the inspection position information storage section 204, the reference position information storage section 206, the image data storage section 208, and the converted image storage section 211 are realized by, for example, a semiconductor storage device, a magnetic hard disk device, or the combination of these devices.

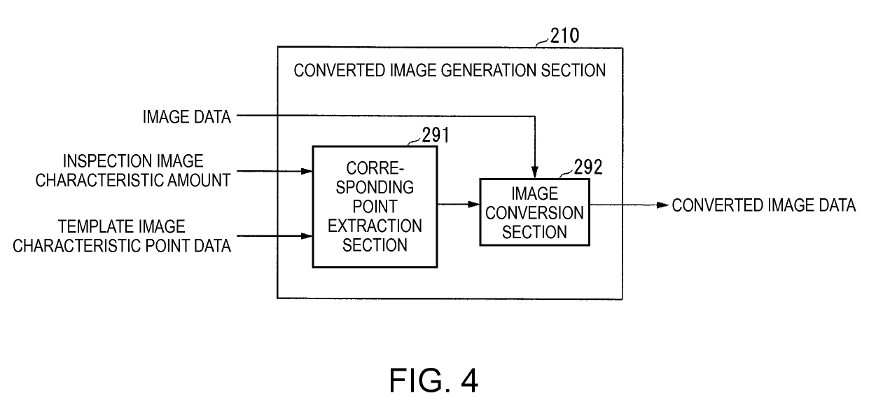

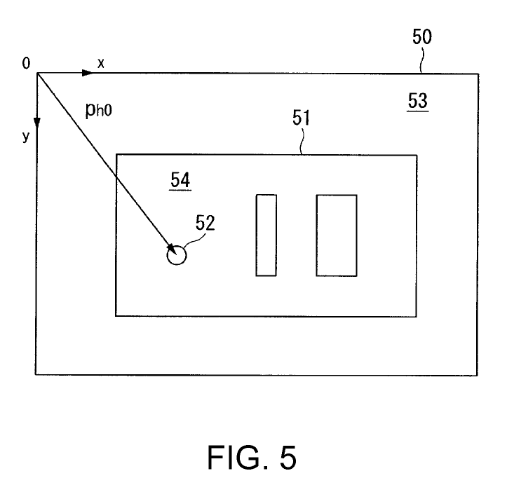

FIG. 4 is a block diagram showing a functional configuration of the converted image generation section 210. As shown in the drawing, the converted image generation section 210 is provided with a corresponding point extraction section 291 and an image conversion section 292.

The corresponding point extraction section 291 acquires the inspection image feature value supplied from the inspection image feature point extraction section 209, and reads the template image feature point data from the template image feature point storage section 203. Then, the corresponding point extraction section 291 calculates the Euclidean distance with respect to all of the combinations of the inspection image feature values and the image feature values of the template image data, then selects the pair of the inspection image feature value and the image feature value of the template image data in the case of having the value of the distance smaller than a threshold value determined in advance as the corresponding pair, and then supplies it to the image conversion section 292.

The image conversion section 292 acquires the corresponding pair of the inspection image feature value and the image feature value of the template image data supplied from the corresponding point extraction section 291, and reads the image data from the image data storage section 208. Then, the image conversion section 292 obtains a homography matrix based on the corresponding pair of the inspection image feature value and the image feature value of the template image data. Here, the homography matrix will be explained. It is assumed that the coordinate system of the imaging device in the three-dimensional space is F*, and an image of the point A in an image obtained by the imaging device taking the image of an arbitrary point A is p (boldface)*=[u* v* 1]^{T}. It should be noted that the description of “(boldface)” denotes that the character immediately before the description is written in boldface type, and shows that the character represents a vector or a matrix. The imaging device described above is displaced, and it is assumed that the coordinate system of the imaging device in the destination is F, and an image of the point A in the image obtained by the imaging device taking the image of the point A described above is p (boldface)=[u v 1]^{T}. Further, it is assumed that a translation vector representing the relative distance between F* and F is t(boldface), and a rotation vector representing an attitude variation is R(boldface).

In the case in which the point A exists on a plane π, the case in which Formula (2) below becomes true as the formula representing the relationship between a point p (boldface)* and a point p(boldface) is considered. It should be noted that the symbol s denotes a value determined by the ratio between the distance between the point A and the coordinate system F* and the distance between the point A and the coordinate system F. The symbol G(boldface) denotes the homography matrix.

sp=Gp* (2)

The homography matrix G(boldface) is a 3×3 matrix, and is expressed as Formula (3) described below.

$$G = [ \begin{matrix}{g}_{11} & {g}_{12} & {g}_{13} \\ {g}_{21} & {g}_{22} & {g}_{23} \\ {g}_{31} & {g}_{32} & {g}_{33}\end{matrix} ] \qquad ( 3 )$$

Further, the homography matrix G(boldface) can be expressed as Formula (4) described below. It should be noted that the symbol d denotes the distance between the imaging device and the plane π, and the symbol n(boldface) denotes a normal vector of the plane π.

G=dR+tn^{T} (4)

If the homography matrix G(boldface) can be estimated, the translation vector t(boldface), the rotation vector R(boldface), the normal vector n(boldface) of the plane π, and the distance d between the imaging device and the plane π can be calculated.

In all of the points existing on the plane π, a set of the coordinates of the projected point obtained by projecting each of the points to the taken image can be expressed as follows using Formula (2). Firstly, the value s is defined as Formula (5) described below.

s=g₃₁u*+g₃₂v*+g₃₃ (5)

According to Formulas (2) and (5), Formula (6) described below is obtained. It should be noted that the symbol w(boldface) is a function of the homography matrix G(boldface), and is a perspective projection conversion matrix. The conversion of the point p(boldface)* into the corresponding point p(boldface) using the perspective projection conversion matrix is referred to as a perspective projection conversion.

$$p = \frac{{Gp}^{*}}{s} = w ( G ) ( {p}^{*} ) = [ \begin{matrix}\frac{{g}_{11} {u}^{*} + {g}_{12} {v}^{*} + {g}_{13}}{{g}_{31} {u}^{*} + {g}_{32} {v}^{*} + {g}_{33}} \\ \frac{{g}_{21} {u}^{*} + {g}_{22} {v}^{*} + {g}_{23}}{{g}_{31} {u}^{*} + {g}_{32} {v}^{*} + {g}_{33}} \\ 1\end{matrix} ] \qquad ( 6 )$$

According to Formula (6), if the homography matrix of the plane π is known, regarding the point existing on the plane π, the point on one taken image corresponding to the point on the other taken image can uniquely be obtained.

Therefore, by obtaining the homography matrix, it is possible to obtain how much the image of interest translates and rotates with respect to the original image, in other words, to perform tracking of the area of interest.

The image conversion section 292 applies the homography matrix thus obtained to thereby perform the perspective projection conversion on the image data read from the image data storage section 208 to be converted into the converted image data as the data of the image from the viewpoint to the template image, and then stores it to the converted image storage section 211.

FIG. 5 is a diagram schematically showing a template image and position information of an inspection area in the template image in an overlapping manner. In the drawing, the template image 50 includes an inspection target object image 51. The image area other than the inspection target object image 51 in the template image 50 corresponds to a background image 53. The background image 53 is plain so that no feature point appears. The inspection target object image 51 includes an inspection area 52 and the reference area 54 adjacent to the inspection area 52. The inspection area 52 is an image area in the condition in which the inspection object is present. Further, the reference area 54 is a flat image area with no structure, and located adjacent to the inspection area 52.

In the two-dimensional coordinate system having the upper left end of the template image 50 as the origin, a horizontal axis direction as the x axis, and a vertical axis direction as the y axis, the position vector p(boldface)ₕ₀ of the center point of the inspection area 52 is information included in the inspection position information.

Then, the operation of the inspection device 20 according to the present embodiment will be explained.

Firstly, the process of the inspection device 20 generating the template image feature point data will be explained. The template image feature point data generation process is sufficiently performed once for each template image data.

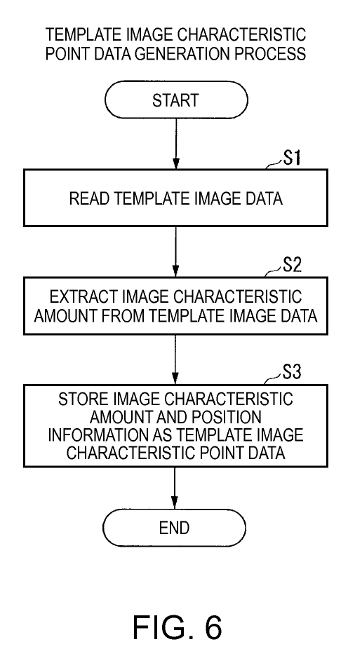

FIG. 6 is a flowchart showing a procedure of the process of the inspection device 20 generating the template image feature point data.

In the step S1, the template image feature point extraction section 202 reads the template image data from the template image storage section 201.

Subsequently, in the step S2, the template image feature point extraction section 202 extracts a plurality of feature points from the template image data. For example, the template image feature point extraction section 202 performs the process using the SIFT method to thereby extract the SIFT feature value. Subsequently, in the step S3, the template image feature point extraction section 202 stores the template image feature point data, which has the image feature value in each of the feature points extracted in the process of the step S2 and the position information on the template image corresponding to each other, to the template image feature point storage section 203. The position information on the template image corresponds to the position vectors of the respective feature points in the template image.

Then, the process of the inspection device 20 determining the reference area will be explained. The reference area determination process is sufficiently performed once for each of the inspection area of the template image.

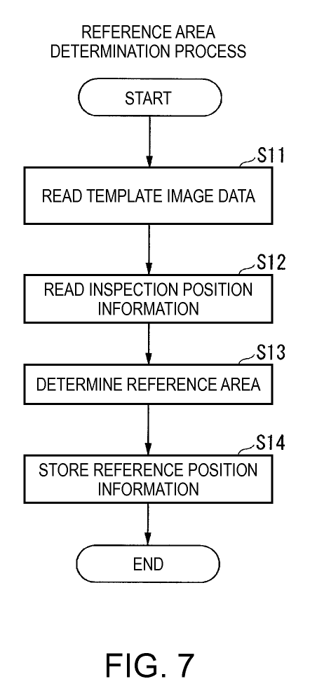

FIG. 7 is a flowchart showing a procedure of a process of the inspection device 20 determining the reference area. In the step S11, the reference area determination section 205 reads the template image data from the template image storage section 201.

Subsequently, in the step S12, the reference area determination section 205 reads the inspection position information from the inspection position information storage section 204.

Subsequently, in the step S13, the reference area determination section 205 determines a flat area adjacent to the inspection area to be specified by the inspection position information as the reference area in the template image data. For example, the reference area determination section 205 analyzes an image within the circular area defined by the length of the radius determined in advance from the center position of the inspection area, and then detects the area having the spatial frequency component smaller than the threshold value determined in advance from the circular image area to thereby determine the area as the reference area.

Subsequently, in the step S14, the reference area determination section 205 stores the reference position information specifying the reference area thus determined to the reference position information storage section 206. The reference position information corresponds to the position vector of the center point of the circular area as the reference area and the length of the radius of the circular area. Then, the inspection process of the inspection device 20 will be explained.

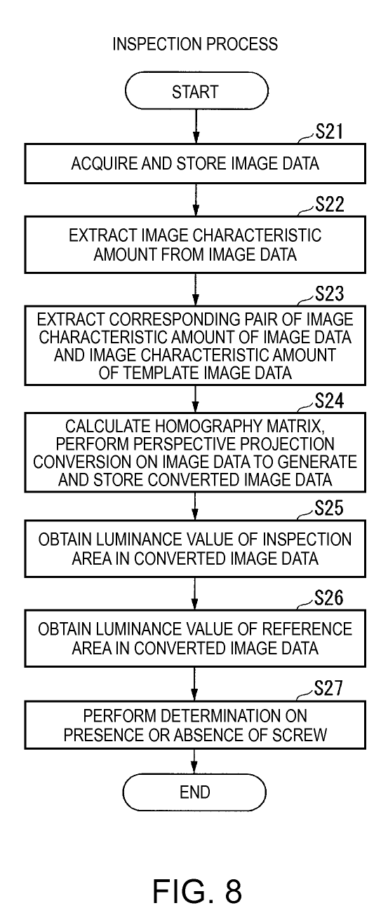

FIG. 8 is a flowchart showing a procedure of a process of the inspection device 20 inspecting missing of a screw as the inspection object with respect to single frame image data of the inspection target object taken by the imaging device 11. In the step S21, when acquiring the one frame of image data output by the imaging device 11 of the robot 10, the image data acquisition section 207 stores the image data to the image data storage section 208.

Subsequently, in the step S22, the inspection image feature point extraction section 209 reads the image data from the image data storage section 208, then extracts a plurality of feature points, and then supplies the converted image generation section 210 with the feature value (inspection image feature value) in each of the feature points. For example, the inspection image feature point extraction section 209 performs the process using the SIFT method to thereby obtain the SIFT feature value, and then supplies it to the converted image generation section 210.

Subsequently, in the step S23, the corresponding point extraction section 291 of the converted image generation section 210 acquires the inspection image feature value supplied from the inspection image feature point extraction section 209, and reads the template image feature point data from the template image feature point storage section 203. Subsequently, the corresponding point extraction section 291 calculates the Euclidean distance with respect to all of the combinations of the inspection image feature values and the image feature values of the template image data.

Subsequently, the corresponding point extraction section 291 selects the pair of the inspection image feature value and the image feature value of the template image data in the case in which the value of the distance thus calculated is smaller than the threshold value determined in advance as the corresponding pair, and then supplies it to the image conversion section 292. Subsequently, in the step S24, the image conversion section 292 acquires the corresponding pair of the inspection image feature value and the image feature value of the template image data supplied from the corresponding point extraction section 291, and reads the image data from the image data storage section 208.

Subsequently, the image conversion section 292 obtains the homography matrix based on the corresponding pair of the inspection image feature value and the image feature value of the template image data.

Subsequently, the image conversion section 292 applies the homography matrix thus obtained to thereby perform the perspective projection conversion on the image data to be converted into the converted image data as the data of the image of the viewpoint to the template image, and then stores it to the converted image storage section 211.

Subsequently, in the step S25, the inspection area luminance value detection section 212 reads the converted image data from the converted image storage section 211, and reads the inspection position information from the inspection position information storage section 204.

Subsequently, the inspection area luminance value detection section 212 detects the inspection area luminance value of the inspection area specified by the inspection position information in the converted image data, for example, an average value of the luminance values of the respective pixels in the inspection area, and then supplies the determination section 214 with the inspection area luminance value.

Subsequently, in the step S26, the reference area luminance value detection section 213 reads the converted image data from the converted image storage section 211, and reads the reference position information from the reference position information storage section 206.

Subsequently, the reference area luminance value detection section 213 detects the reference area luminance value of the reference area specified by the reference position information in the converted image data, for example, an average value of the luminance values of the respective pixels in the reference area, and then supplies the determination section 214 with the reference area luminance value.

Subsequently, in the step S27, the determination section 214 acquires the inspection area luminance value supplied from the inspection area luminance value detection section 212, and acquires the reference area luminance value supplied from the reference area luminance value detection section 213.

Subsequently, the determination section 214 determines whether or not the screw is present in the inspection area based on the inspection area luminance value and the reference area luminance value, and then outputs the inspection result data as the determination result. For example, the determination section 214 calculates the luminance ratio lₛ′ using Formula (1) described above. Then, if the luminance ratio lₛ′ is a value equal to or lower than a threshold value determined in advance, the determination section 214 determines that the screw is present in the inspection area, and outputs the information (e.g., “1”) representing the fact that the screw is present as the inspection result data. In contrast, if the luminance ratio lₛ′ is a value exceeding the threshold value, the determination section 214 determines that the screw is absent in the inspection area, and outputs the information (e.g., “0”) representing the fact that the screw is absent as the inspection result data.

If the inspection device 20 processes the image data of the next frame to be supplied from the imaging device 11, the process returns to the step S21, and a series of steps of the flowchart will be performed.

According to the robotic device 1 of the first embodiment of the invention, the imaging device 11 provided to the hand section 12c of the robot main body 12 takes the image of the inspection region of the inspection target object 5 in an arbitrary direction in the three-dimensional space. Then, the inspection device 20 of the robotic device 1 converts the image data into the converted image data so that the viewpoint with respect to the inspection target object image included in the image data obtained by the imaging device 11 taking the image from the arbitrary direction coincides with the viewpoint with respect to a template image included in the template image data stored in advance. Then, the inspection device 20 determines presence or absence of the screw from the inspection area in the converted image data, and then outputs the inspection result data.

Since such a configuration is adopted, it is possible for the inspection device 20 to perform inspection of the state of the inspection region using the image data taken from an arbitrary direction in the three-dimensional space.

Further, in the inspection device 20, the determination section 214 calculates the luminance ratio lₛ′ as the ratio between the inspection area luminance value lₛ and the reference area luminance value lᵣ based on the inspection area luminance value lₛ detected by the inspection area luminance value detection section 212 and the reference area luminance value lᵣ detected by the reference area luminance value detection section 213, and then inspects the state of the inspection area in the converted image data in accordance with the luminance ratio lₛ′.

Since such a configuration is adopted, the inspection device 20 can correctly perform the inspection of the state of the inspection area even in the case in which the imaging device 11 performs the automatic exposure adjustment in response to the variation in the intensity of the illumination. In other words, the inspection device 20 can correctly perform the inspection of the state of the inspection area while suppressing the influence of the outside light and the illumination.

Further, since the inspection device 20 uses the average values of the luminance values of the respective pixels in the inspection area and the reference area, a camera for obtaining a monochrome image can be used as the imaging device 11. Therefore, according to the robotic device 1 of the present embodiment, the monochrome image can be used, and thus, the appearance inspection robust with respect to the variation in the illumination conditions and the imaging conditions can be performed.

### Second Embodiment

The robotic device 1 according to the first embodiment is a device of inspecting presence or absence of the screw as the inspection object from the image data obtained by taking the image of the inspection target object 5 from an arbitrary direction in a three-dimensional space. The robotic device according to the second embodiment is a device of inspecting presence or absence of the screw from the image data obtained by performing imaging while making translational displacement of the imaging device above the inspection region of the inspection target object.

In the present embodiment, the constituents identical to those in the first embodiment will be denoted by the same reference symbols, and the explanation therefor will be omitted.

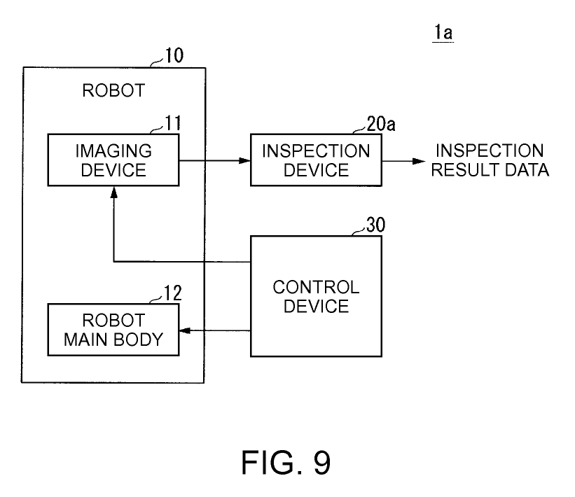

FIG. 9 is a block diagram showing a schematic functional configuration of the robotic device according to the present embodiment. In the drawing, the robotic device 1a has a configuration obtained by replacing the inspection device 20 in the robotic device 1 with an inspection device 20a.

The inspection device 20a acquires the image data, which is continuously output by the imaging device 11 of the robot 10, sequentially or every several frames. Further, the inspection device 20a obtains the displacement of the inspection target object image included in the image data with respect to the template image of the inspection target object included in the template image data stored in advance for each image data thus acquired. Then, the inspection device 20a identifies the inspection area from the image data based on the displacement to thereby determine presence or absence of the head of the screw as the inspection object, and then outputs the inspection result data.

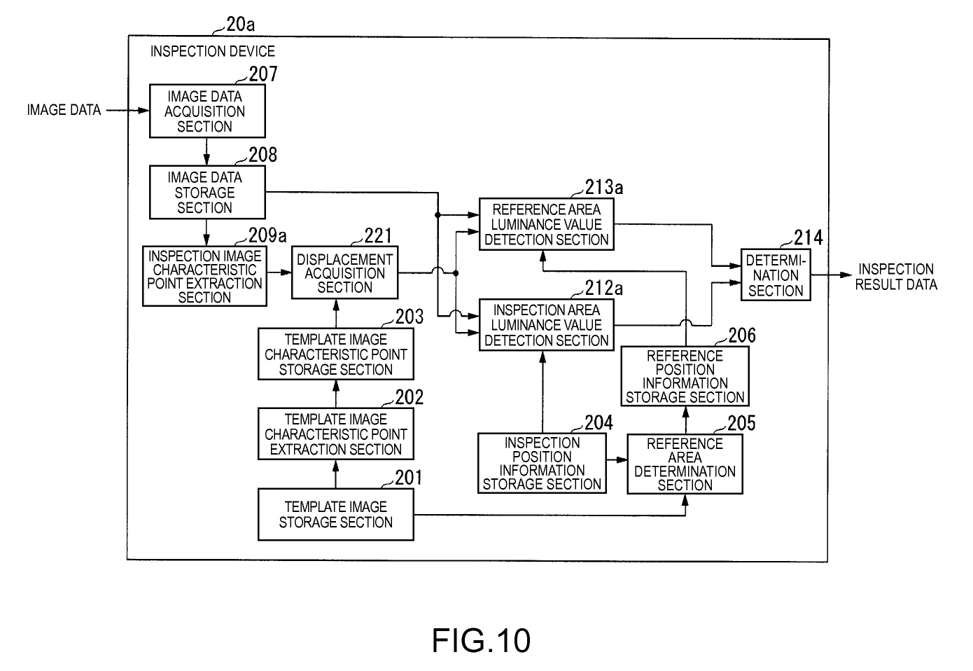

FIG. 10 is a block diagram showing a functional configuration of the inspection device 20a. In the drawing, the inspection device 20a has a configuration obtained by replacing the inspection image feature point extraction section 209, the converted image generation section 210, the inspection area luminance value detection section 212, and the reference area luminance value detection section 213 in the inspection device 20 in the first embodiment with an inspection image feature point extraction section 209a, a displacement acquisition section 221, an inspection area luminance value detection section 212a, and a reference area luminance value detection section 213a.

The inspection image feature point extraction section 209a reads the image data from the image data storage section 208, then extracts a plurality of feature points from the image data, and then supplies the inspection image feature point data having the feature value (inspection image feature value) in each of the feature points and the position information on the image corresponding to each other to the displacement acquisition section 221. For example, the inspection image feature point extraction section 209a performs the process using the SIFT method to thereby obtain the SIFT feature value. Further, the inspection image feature point extraction section 209a can apply the SURF described above as the feature point extraction method.

The position information on the image is a position vector of the feature point obtained by using, for example, the upper left end position of the image as the origin.

The displacement acquisition section 221 acquires the inspection image feature point data supplied from the inspection image feature point extraction section 209a, and reads the template image feature point data from the template image feature point storage section 203. Then, the displacement acquisition section 221 obtains the Euclidean distance with respect to all of the combinations of the inspection image feature values and the image feature values of the template image data to thereby select the pair (corresponding pair) having the inspection image feature value and the image feature value of the template image data in a correspondence relationship. Then, the displacement acquisition section 221 calculates the displacement based on the pair (the position information pair) of the position information on the image corresponding to the corresponding pair, and supplies the displacement to the inspection area luminance value detection section 212a and the reference area luminance value detection section 213a.

The inspection area luminance value detection section 212a acquires the displacement supplied from the displacement acquisition section 221, reads the image data from the image data storage section 208, and reads the inspection position information from the inspection position information storage section 204. Then, the inspection area luminance value detection section 212a detects the luminance value (the inspection area luminance value) of the inspection area specified by the inspection position information and the displacement in the image data, and then supplies it to the determination section 214. The inspection area luminance value is, for example, an average value of the luminance values of the respective pixels in the inspection area.

The reference area luminance value detection section 213a acquires the displacement supplied from the displacement acquisition section 221, reads the image data from the image data storage section 208, and reads the reference position information from the reference position information storage section 206. Then, the reference area luminance value detection section 213a detects the luminance value (the reference area luminance value) of the reference area specified by the reference position information and the displacement in the image data, and then supplies it to the determination section 214. The reference area luminance value is, for example, an average value of the luminance values of the respective pixels in the reference area.

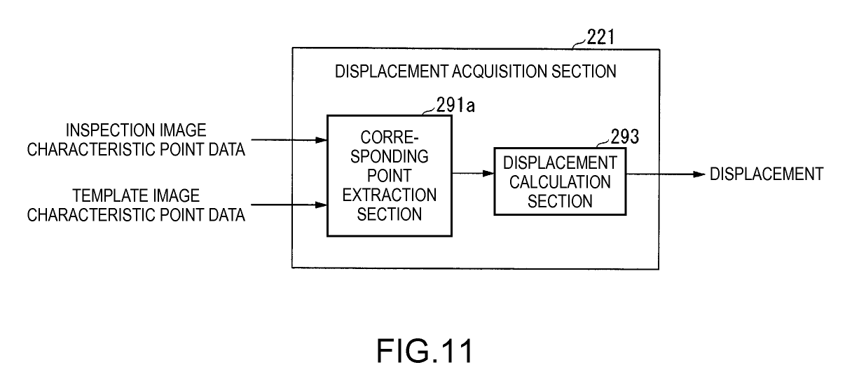

FIG. 11 is a block diagram showing a functional configuration of the displacement acquisition section 221. As shown in the drawing, the displacement acquisition section 221 is provided with a corresponding point extraction section 291a and an displacement calculation section 293.

The corresponding point extraction section 291a acquires the inspection image feature point data supplied from the inspection image feature point extraction section 209a, and reads the template image feature point data from the template image feature point storage section 203. Then, the corresponding point extraction section 291a calculates the Euclidean distance with respect to all of the combinations of the inspection image feature values of the inspection image feature point data and the image feature values of the template image data, and then selects the pair of the inspection image feature value and the image feature value of the template image data in the case of having the value of the distance smaller than a threshold value determined in advance as the corresponding pair. Then, the corresponding point extraction section 291a supplies the displacement calculation section 293 with the position information pair on the image corresponding to the corresponding pair.

The displacement calculation section 293 acquires the position information pair supplied from the corresponding point extraction section 291a, and then calculates the displacement of the feature point for each pair. Then, the displacement calculation section 293 selects the mode value out of the displacement values of all of the feature points, and then supplies the inspection area luminance value detection section 212a and the reference area luminance value detection section 213a with the mode value thus selected as the displacement. It should be noted that the displacement calculation section 293 can also determine the average or the median of the displacement values of all of the feature points as the displacement.

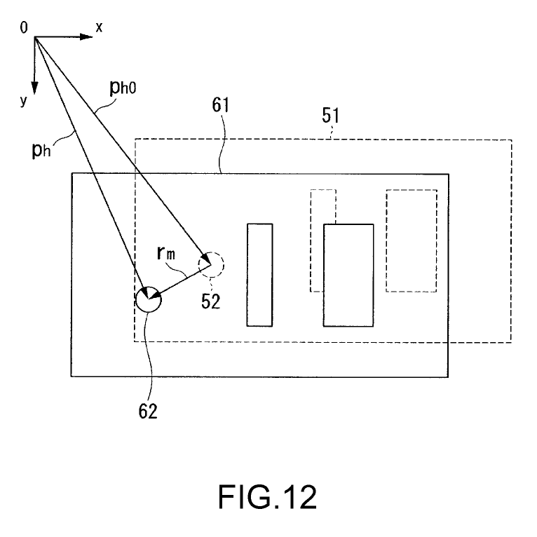

FIG. 12 is a diagram schematically showing an inspection target object image and position information of the inspection area in the template image data and the image data in an overlapping manner. In the drawing, the figures indicated by the broken lines correspond to the inspection target object image in the template image data, and the figures indicated by the solid lines correspond to the inspection target object image in the image data. The inspection target object image 51 in the template image data includes the inspection area 52. Further, the inspection target object image 61 in the image data includes the inspection area 62.

In the two-dimensional coordinate system having the upper left end of the template image as the origin, a horizontal axis direction as the x axis, and a vertical axis direction as the y axis, the position vector p (boldface) ₕ₀ of the center point of the inspection area 52 in the template image data is the information included in the inspection position information. Further, the vector r(boldface)ₘ from the center point of the inspection area 52 in the template image data to the center point of the inspection area 62 in the image data corresponds to the displacement output by the displacement acquisition section 221. Therefore, it is possible to obtain the position vector p (boldface) ₕ of the center point of the inspection area 62 in the image data based on the position vector p (boldface) ₕ₀ of the center point of the inspection area 52 in the template image data and the vector r(boldface)ₘ as the displacement. Then, the operation of the inspection device 20a according to the present embodiment will be explained. Here, the inspection process of the inspection device 20a will be explained.

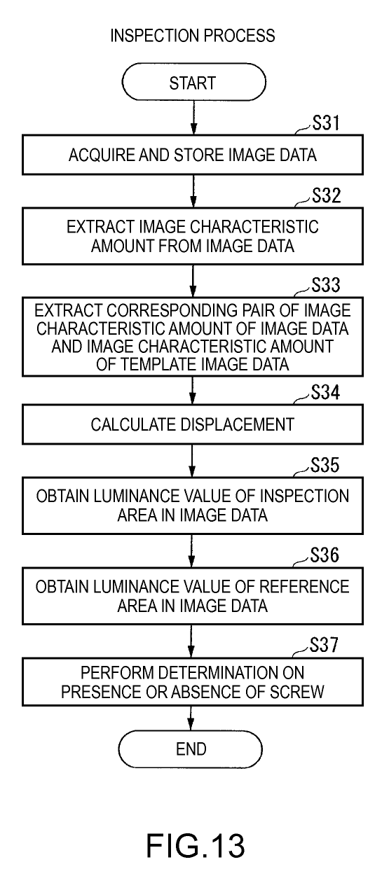

FIG. 13 is a flowchart showing a procedure of a process of the inspection device 20a inspecting missing of a screw with respect to the single frame image data of the inspection target object taken by the imaging device 11.

In the step S31, when acquiring the one frame of image data output by the imaging device 11 of the robot 10, the image data acquisition section 207 stores the image data to the image data storage section 208.

Subsequently, in the step S32, the inspection image feature point extraction section 209a reads the image data from the image data storage section 208, then extracts a plurality of feature points, and then supplies the displacement acquisition section 221 with the inspection image feature point data having the feature value (inspection image feature value) in each of the feature points and the position information on the image corresponding to each other. For example, the inspection image feature point extraction section 209a performs the process using the SIFT method to thereby obtain the SIFT feature value, and then supplies it to the displacement acquisition section 221.

Subsequently, in the step S33, the corresponding point extraction section 291a of the displacement acquisition section 221 acquires the inspection image feature point data supplied from the inspection image feature point extraction section 209a, and reads the template image feature point data from the template image feature point storage section 203.

Subsequently, the corresponding point extraction section 291a calculates the Euclidean distance with respect to all of the combinations of the inspection image feature values of the inspection image feature point data and the image feature values of the template image data.

Subsequently, the corresponding point extraction section 291a selects the pair of the inspection image feature value and the image feature value of the template image data in the case in which the value of the distance thus calculated is smaller than the threshold value determined in advance as the corresponding pair. Then, the corresponding point extraction section 291a supplies the displacement calculation section 293 with the pair (the position information pair) of the position information on the image corresponding to the corresponding pair.

Subsequently, in the step S34, the displacement calculation section 293 acquires the position information pair supplied from the corresponding point extraction section 291a, and then calculates the displacement of the feature point for each pair. Then, the displacement calculation section 293 selects the mode value out of the displacement values of all of the feature points, and then supplies the inspection area luminance value detection section 212a and the reference area luminance value detection section 213a with the mode value thus selected as the displacement.

Subsequently, in the step S35, the inspection area luminance value detection section 212a acquires the displacement supplied from the displacement acquisition section 221, reads the image data from the image data storage section 208, and reads the inspection position information from the inspection position information storage section 204.

Subsequently, the inspection area luminance value detection section 212a detects the inspection area luminance value of the inspection area specified by the inspection position information in the image data and the displacement, for example, an average value of the luminance values of the respective pixels in the inspection area, and then supplies the determination section 214 with the inspection area luminance value.

Subsequently, in the step S36, the reference area luminance value detection section 213a acquires the displacement supplied from the displacement acquisition section 221, reads the image data from the image data storage section 208, and reads the reference position information from the reference position information storage section 206.

Subsequently, the reference area luminance value detection section 213a detects the reference area luminance value of the reference area specified by the reference position information in the image data and the displacement, for example, an average value of the luminance values of the respective pixels in the reference area, and then supplies the determination section 214 with the reference area luminance value.

Subsequently, in the step S37, the determination section 214 acquires the inspection area luminance value supplied from the inspection area luminance value detection section 212a, and acquires the reference area luminance value supplied from the reference area luminance value detection section 213a.

Subsequently, the determination section 214 determines whether or not the screw is present in the inspection area based on the inspection area luminance value and the reference area luminance value, and then outputs the inspection result data as the determination result. Specifically, since the process is substantially the same as the process of the step S27 in the first embodiment described above, the explanation will be omitted here.

If the inspection device 20a processes the image data of the next frame to be supplied from the imaging device 11, the process returns to the step S31, and a series of steps of the flowchart will be performed.

According to the robotic device la of the second embodiment of the invention, the imaging device 11 provided to the hand section 12c of the robot main body 12 makes the translational displacement in the area above the inspection region of the inspection target object 5 to thereby take the image of the inspection region. Further, the inspection device 20a of the robotic device la obtains the displacement of the inspection target object image included in the image data with respect to the template image of the inspection target object included in the template image data stored in advance. Then, the inspection device 20a identifies the inspection area from the image data based on the displacement to thereby determine presence or absence of the screw, and then outputs the inspection result data.

Since such a configuration is adopted, it is possible for the inspection device 20a to perform inspection of the state of the inspection region using the image data taken by the imaging device 11 while making translational displacement.

Further, in the inspection device 20a, the determination section 214 calculates the luminance ratio 1ₛ′ as the ratio between the inspection area luminance value lₛ and the reference area luminance value lᵣ based on the inspection area luminance value lₛ detected by the inspection area luminance value detection section 212a and the reference area luminance value lᵣ detected by the reference area luminance value detection section 213a, and then inspects the state of the inspection area in the image data in accordance with the luminance ratio lₛ′.

Since such a configuration is adopted, the inspection device 20a can correctly perform the inspection of the state of the inspection area even in the case in which the imaging device 11 performs the automatic exposure adjustment in response to the variation in the intensity of the illumination. In other words, the inspection device 20a can correctly perform the inspection of the state of the inspection area while suppressing the influence of the outside light and the illumination.

Further, since the inspection device 20a uses the average values of the luminance values of the respective pixels in the inspection area and the reference area, a camera for obtaining a monochrome image can be used as the imaging device 11. Therefore, according to the robotic device la of the present embodiment, the monochrome image can be used, and thus, the appearance inspection robust with respect to the variation in the illumination conditions and the imaging conditions can be performed.

A specific example of the inspection area luminance value lₛ and the reference area luminance value lᵣ detected by the inspection device 20 in the robotic device 1 according to the first embodiment and the inspection device 20a in the robotic device 1a according to the second embodiment described above, and the luminance ratio lₛ′ obtained based on these values will be shown in Table 1 described below.

TABLE 1

| | ENVIRONMENTAL | | | |
|---|---|---|---|---|
| | CONDITIONS | lᵣ | lₛ | lₛ′ |
| SCREW IS ABSENT | CONDITION A | 72 | 50 | 0.69 |
| | CONDITION B | 155 | 97 | 0.63 |
| SCREW IS PRESENT | CONDITION A | 71 | 69 | 0.97 |
| | CONDITION B | 153 | 135 | 0.88 |

The specific example shown in Table 1 corresponds to the data in the case of adopting the camera automatically performing the exposure adjustment in accordance with the illuminance as the imaging device 11. In the table, “ENVIRONMENTAL CONDITIONS” are conditions of the illumination environment of the imaging device 11 and the object of shooting, and in the example, the illumination in the condition A is darker than the illumination in the condition B.

According to the data in the table, although the inspection area luminance value lₛ and the reference area luminance value lᵣ are each different between the environmental conditions, the luminance ratio lₛ′ has roughly the same values. Therefore, by setting the threshold value to, for example, 0.8, the determination section 214 can correctly determine the presence or absence of the screw without being affected by the environmental conditions.

It should be noted that in the first and second embodiments, the reference area determination section 205 of the inspection device 20, 20a is a section for determining the reference area from the template image of the template image data stored in the template image storage section 201, and then storing the reference position information of the reference area to the reference position information storage section 206. Besides the above, it is also possible to arrange, for example, that the operator of the inspection device 20, 20a designates the reference area out of the template image, and then stores the reference position information of the reference area to the reference position information storage section 206.

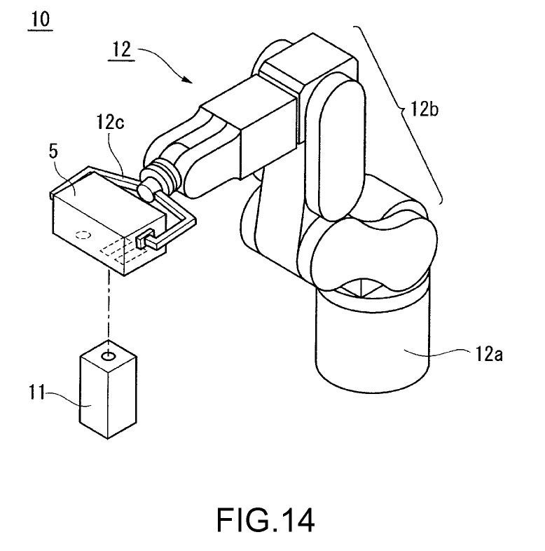

Further, in the first and second embodiments, it is also possible to arrange that the imaging device 11 is fixedly installed, and the inspection target object 5 is moved as shown in FIG. 14.

In contrast to FIG. 1, in FIG. 14, the imaging device 11 is fixedly installed, and the robot main body 12 movably supports the inspection target object 5. The robot main body 12 moves the inspection region of the inspection target object 5 as the object of shooting with respect to the imaging device 11 due to the linkage operation of the support base 12a, the arm section 12b, and the hand section 12c. On this occasion, by, for example, setting the shooting axis of the imaging device 11 to vertical direction, and translating the inspection region of the inspection target object 5 while facing to the imaging device 11, in other words, by limiting the relative displacement between the image of the inspection region of the inspection target object 5 and the template image only to a plane, the inspection device 20, 20a can perform the inspection with ease.

Further, in the second embodiment, the robot main body 12 can be a Cartesian coordinate robot only making translational displacement.

Further, it is also possible to arrange that the functions of the inspection device 20, 20a in the first and second embodiments are partially realized by a computer. In this case, it is also possible to realize such functions by recording the inspection program for realizing the control functions on a computer-readable recording medium, and then making the computer system retrieve and then execute the inspection program recorded on the recording medium. It should be noted that the “computer system” mentioned here should include an operating system (OS) and the hardware of the peripheral devices. Further, the “computer-readable recording medium” denotes a portable recording medium such as a flexible disk, a magneto-optical disk, an optical disk, or a memory card, and a storage device such as a magnetic hard disk incorporated in the computer system. Further, the “computer-readable recording medium” can include those dynamically holding a program for a short period of time such as a communication line in the case of transmitting the program via a communication line such as a telephone line or a network such as the Internet, and those holding a program for a certain period of time such as a volatile memory in a server device or a computer system to be a client in that occasion. Further, the program described above can be those for partially realizing the functions described above, or those realizing the functions described above in combination with a program already recorded on the computer system.

Although the embodiments of the invention are hereinabove described in detail with reference to the accompanying drawings, the specific configuration is not limited to the embodiments described above, but designs and so on within the scope or the spirit of the invention are also included therein. The entire disclosure of Japanese Patent Application No. 2011-021878, filed Feb. 3, 2011 is expressly incorporated by reference herein.

What is claimed is:

1. A robotic device comprising:
an imaging section adapted to take an image of an inspection target object having an inspection region, and generate an image data of an inspection target object image including an inspection area as an image area including the inspection region;
a robot main body adapted to movably support the imaging section;
an inspection area luminance value detection section adapted to detect a luminance value of the inspection area from the image data generated by the imaging section;
a reference area luminance value detection section adapted to detect a luminance value of a reference area adjacent to the inspection area from the image data; and
a determination section adapted to determine a state of the inspection area based on one of a ratio and a difference between the luminance value of the inspection area detected by the inspection area luminance value detection section and the luminance value of the reference area detected by the reference area luminance value detection section.

2. The robotic device according to claim 1, wherein the reference area is an area, which is surrounded by a circle centered on a center position of the inspection area, and excludes the inspection area.

3. The robotic device according to claim 1, wherein
the reference area luminance value detection section detects the luminance value of the reference area, which is an area having a spatial frequency component smaller than a threshold value, from the image data.

4. The robotic device according to claim 1, wherein
the reference area luminance value detection section detects the luminance value of the reference area, which is an area having a reflectance lower than a threshold level, from the image data.

5. The robotic device according to claim 1, further comprising:
a template image storage section adapted to store template image data of the inspection target object; and
a reference area determination section adapted to determine an area adjacent to the inspection area as the reference area in the template image data stored in the template image storage section,
wherein the reference area luminance value detection section detects a luminance value of an area of the image data in the reference area determined by the reference area determination section.

6. The robotic device according to claim 5, wherein
the reference area determination section determines an area, which is adjacent to the inspection area, and has a spatial frequency component smaller than a threshold value, as the reference area in the template image data stored in the template image storage section.

7. The robotic device according to claim 5, wherein
the reference area determination section determines an area, which is adjacent to the inspection area, and has a reflectance lower than a threshold level, as the reference area in the template image data stored in the template image storage section.

8. The robotic device according to claim 5, wherein
the area adjacent to the inspection area is an area, which is surrounded by a circle centered on a center position of the inspection area, and excludes the inspection area.

9. The robotic device according to claim 5, further comprising:
a template image feature point extraction section adapted to extract a feature point from the template image data stored in the template image storage section;
an inspection image feature point extraction section adapted to extract a feature point from the image data generated by the imaging section; and
a converted image generation section adapted to perform perspective projection conversion on the image data to thereby generate converted image data based on the feature point extracted by the template image feature point extraction section and the feature point extracted by the inspection image feature point extraction section,
wherein the robot main body movably supports the imaging section in a three-dimensional space,
the inspection area luminance value detection section detects the luminance value of the inspection area from the converted image data generated by the converted image generation section, and
the reference area luminance value detection section detects the luminance value of the reference area determined by the reference area determination section from the converted image data.

10. The robotic device according to claim 5, further comprising:
a template image feature point extraction section adapted to extract a feature point from the template image data stored in the template image storage section;
an inspection image feature point extraction section adapted to extract a feature point from the image data generated by the imaging section; and
a displacement acquisition section adapted to acquire a displacement of the inspection target object image of the image data with respect to the template image of the template image data based on the feature point extracted by the template image feature point extraction section and the feature point extracted by the inspection image feature point extraction section,
wherein the robot main body supports the imaging section so as to be able to translate in a three-dimensional space, and
the reference area luminance value detection section detects a luminance value of an area specified based on the image data and the displacement acquired by the displacement acquisition section.

11. An inspection device comprising:
an inspection area luminance value detection section adapted to detect a luminance value of an inspection area from image data including the inspection area;
a reference area luminance value detection section adapted to detect a luminance value of a reference area adjacent to the inspection area from the image data; and
a determination section adapted to determine a state of the inspection area based on one of a ratio and a difference between the luminance value of the inspection area detected by the inspection area luminance value detection section and the luminance value of the reference area detected by the reference area luminance value detection section.

12. The inspection device according to claim 11, wherein
the reference area is an area, which is surrounded by a circle centered on a center position of the inspection area, and excludes the inspection area.

13. An inspection method comprising:
allowing an inspection area luminance value detection section to detect a luminance value of an inspection area from image data including the inspection area;
allowing a reference area luminance value detection section to detect a luminance value of a reference area adjacent to the inspection area from the image data; and
allowing a determination section to determine a state of the inspection area based on one of a ratio and a difference between the luminance value of the inspection area detected by the inspection area luminance value detection section in the detection of the luminance value of the inspection area and the luminance value of the reference area detected by the reference area luminance value detection section in the detection of the luminance value of the reference area.

14. The inspection method according to claim 13, wherein
the reference area is an area, which is surrounded by a circle centered on a center position of the inspection area, and excludes the inspection area.

15. An inspection program adapted to allow a computer to function as a device comprising:
an inspection area luminance value detection section adapted to detect a luminance value of an inspection area from image data including the inspection area;
a reference area luminance value detection section adapted to detect a luminance value of a reference area adjacent to the inspection area from the image data; and
a determination section adapted to determine a state of the inspection area based on one of a ratio and a difference between the luminance value of the inspection area detected by the inspection area luminance value detection section and the luminance value of the reference area detected by the reference area luminance value detection section.

16. The inspection program according to claim 15, wherein
the reference area is an area, which is surrounded by a circle centered on a center position of the inspection area, and excludes the inspection area.
